(19) United States
(12) Patent Application Publication
(10) Pub. No.: US 2010/0185703 A1
(43) Pub. Date: Jul. 22, 2010

(54) Lock-free hash table based write barrier buffer for large memory multiprocessor garbage collectors

(75) Inventor: Tatu Ylonen, Espoo (FI)

Correspondence Address: TATU YLONEN OY, LTD., KUTOJANTIE 3, ESPOO, 02630, FI

(73) Assignee: Tatu Ylonen Oy Ltd, Espoo (FI)

(21) Appl. No.: 12/353,327

(22) Filed: Jan. 14, 2009

(51) Int. Cl. G06F 17/30

(52) U.S. Cl. 707/816; 707/E17.002

(57) ABSTRACT

A lock-free write barrier buffer is used to combine multiple writes to identical locations and save old values of written memory locations and to reduce TLB misses compared to card marking. The old value of a written location as well as the address of the header of the written object can be saved, which is not possible with card marking. Scanning the card table and marked pages are eliminated. The method is lock-free, scaling to highly concurrent multiprocessors and multi-core systems.

### CROSS-REFERENCE TO RELATED APPLICATIONS

Not Applicable

### INCORPORATION-BY-REFERENCE OF MATERIAL SUBMITTED ON ATTACHED MEDIA

Not Applicable

### TECHNICAL FIELD

The present invention relates to garbage collection as an automatic memory management method in a computer system, and particularly to the implementation of a write barrier component as part of the garbage collector and application programs.

### BACKGROUND OF THE INVENTION

Garbage collection in computer systems has been studied for about fifty years, and much of the work is summarized in R. Jones and R. Lins: Garbage Collection: Algorithms for Dynamic Memory Management, Wiley, 1996. Even since the publication of this book, the field has seen impressive development due to commercial interest in Java and other similar virtual machine based programming environments.

The book by Jones & Lins discusses write barriers on a number of pages, including but not limited to 150-153, 165-174, 187-193, 199-200, 214-215, 222-223. Page 174 summarizes the research thus far: “For general purpose hardware, two systems look the most promising: remembered sets with sequential store buffers and card marking.”

David Detlefs et al: Garbage—First Garbage Collection, ISMM'04, pp. 37-48, ACM, 2004, which is hereby incorporated herein by reference, on p. 38 describes a modern implementation of a remembered set buffer (RS buffer) as a set of sequences of modified cards. They can use a separate background thread for processing filled RS buffers, or may process them at the start of an evacuation pause. Their system may store the same address multiple times in the RS buffers. Other documents describing various write barrier implementations include Stephen M. Blackburn and Kathryn S. McKinley: In or Out? Putting Write Barriers in Their Place, ISMM'02, pp. 175-184, ACM, 2002; Stephen M. Blackburn and Antony L. Hosking: Barriers: Friend or Foe, ISMM'04, pp. 143-151, ACM, 2004; David Detlefs et al: Concurrent Remembered Set Refinement in Generational Garbage Collection, in USENIX Java VM'02 conference, 2002; Antony L. Hosking et al: A Comparative Performance Evaluation of Write Barrier Implementations, OOPSLA'92, pp. 92-109, ACM, 1992; Pekka P. Pirinen: Barrier techniques for incremental tracing, ISMM'98, pp. 20-25, ACM, 1998; Paul R. Wilson and Thomas G. Moher: A “Card-Marking” Scheme for Controlling Intergenerational References in Generation-Based Garbage Collection on Stock Hardware, ACM SIGPLAN Notices, 24(5):87-92, 1989.

A problem with card marking is that it performs a write to a relatively random location in the card table, and the card table can be very large (for example, in a system with a 64-gigabyte heap and 512 byte cards, the card table requires 128 million entries, each entry typically being a byte, though a single bit could also be used with some additional overhead). The data structure is large enough that writing to it will frequently involve a TLB miss (TLB is translation lookaside buffer, a relatively small cache used for speeding up the mapping of memory addresses from virtual to physical addresses). The cost of a TLB miss on modern processors is on the order of 1000 instructions (or more if the memory bus is busy; it is typical for many applications to be constrained by memory bandwidth especially in modern multi-core systems). Thus, even though the card marking write barrier is conceptually very simple and involves very few instructions, the relatively frequent TLB misses with large memories actually make it rather expensive. The relatively large card table data structures also compete for cache space with application data, thus reducing the cache hit rates for application data and reducing the performance of applications in ways that are very difficult to measure (and ignored in many academic benchmarks).

What is worse, the cards need to be scanned later (usually latest at the next evacuation pause). While the scanning can sometimes be done by idle processors in a multiprocessor (or multicore) system, as applications evolve to better utilize multiple processors, there will not be any idle processors during lengthy compute-intensive operations. Thus, card scanning must be counted in the write barrier overhead.

A further, but more subtle issue is that card scanning requires that it must be possible to determine which memory locations contain pointers within the card. In general purpose computers without special tag bits, this imposes restrictions on how object layouts must be designed, at which addresses (alignment) objects can be allocated and/or may require special bookkeeping for each card.

Applications greatly vary in their write patterns. Some applications make very few writes to non-young objects; some write many times to relatively few non-young locations; and some write to millions and millions of locations all around the heap.

It is desirable to avoid the TLB misses, cache contention and card scanning overhead that are inherent in a card marking scheme. It would also be desirable to eliminate the duplicate entries for the same addresses and the requirement for a separate buffer processing step (that relies on the availability of idle processing cores) that are inherent in using sequential store buffers with remembered sets.

Some known systems maintain remembered sets as a hash table, and access the remembered set hash tables directly from the write barrier, without the use of a remembered set buffer. Such systems have been found to have poorer performance in Antony L. Hosking et al: A Comparative Performance Evaluation of Write Barrier Implementations, OOPSLA'92, pp. 92-109, ACM, 1992 (they call it the Remembered Sets alternative). They also discuss the implementation of remembered sets as circular hash tables using linear hashing on pp. 95-96. It should be noted that they are discussing how their remembered sets are implemented; their write barrier (pp. 96-98) does not appear to be based on a hash table and they do not seem to implement a write barrier buffer as a hash table. The remembered sets are usually much larger than a write barrier buffer, and thus accessing remembered sets directly from the write barrier results in poorer cache locality and TLB miss rate compared to using a write barrier buffer as described later herein, in part explaining the poor benchmark results for their hash table based remembered set approach.

It should be noted that the remembered set data structures and the write barrier buffer are two different things and they perform different functions. The write barrier buffer collects information into a relatively small data structure as quickly as possible, and is typically emptied latest at the next evacuation pause, whereas the remembered sets can be very large on a large system and are slowly changing data, and most of the data in remembered sets lives across many evacuation pauses, often through the entire run of the application.

Multiplicative hash functions, open addressing hash tables, and linear probing are described in D. Knuth: The Art of Computer Programming: Sorting and Searching, Addison-Wesley, 1973, pp. 506-549.

Lock-free hash tables allowing concurrent access are discussed e.g. in H. Gao et al: Efficient Almost Wait-free Parallel Accessible Dynamic Hashtables. CS-Report 03-03, Department of Mathematics and Computer Science, Eindhoven University of Technology, Eindhoven, The Netherlands, 2003; H. Gao: Design and Verification of Lock-free Parallel Algorithms, PhD Thesis, Wiskunde en Natuurwetenschappen, Riksuniversiteit Groningen, 2005, pp. 21-56; David R. Martin and Richard C. Davis: A Scalable Non-Blocking Concurrent Hash Table Implementation with Incremental Rehashing, 1997; Maged M. Michael: High Performance Dynamic Lock-Free Hash Tables and List-Based Sets, SPAA'02, pp. 73-82, ACM, 2002; Ori Shalev and Nir Shavit: Split-Ordered Lists: Lock-Free Extensible Hash Tables, J. ACM, 53(3):379-405, 2006; H. Gao: Design and Verification of Lock-free Parallel Algorithms, PhD Thesis, Wiskunde en Natuurwetenschappen, Riksuniversiteit Groningen, 2005, pp. 21-56.

Other references on the use of non-blocking or lock-free algorithms in garbage collection include e.g. M. P. Herlihy and J. E. B. Moss: Lock-Free Garbage Collection for Multiprocessors, IEEE Transactions on Parallel and Distributed Systems, 3(3):304-311, 1992; F. Pizlo et al: STOPLESS: A Real-time Garbage Collector for Multiprocessors, International Symposium on Memory Management (ISMM), ACM, 2007, pp. 159-172.

Various atomic operations, including compare-and-swap and load linked/store conditional, have been extensively analyzed in the literature. Possible starting points into the literature include H. Gao and W. H. Hesselink: A general lock-free algorithm using compare-and-swap, Information and Computation, 205(2):225-241, 2007 and Victor Luchangco et al: Nonblocking k-compare-single-swap, SPAA'03, pp. 314-323, ACM, 2003.

Many software transactional memory implementations use multiversion concurrency control for read locations, saving a copy of a read object when the object is read. A hash table is frequently used for quickly finding the saved value of a memory location based on its address. Some software transactional memory systems may also save old values of written locations that can be used to restore the memory locations to their original values should the transaction need to be aborted. Again, a hash table may be used for quickly finding such values. These approaches are largely modeled after similar approaches in disk-based transactional database systems, where a log is typically used for storing the old values.

### BRIEF SUMMARY OF THE INVENTION

A lock-free write barrier implementation based on hash tables with various optimizations will be presented. The focus is on what happens in the slow path of the write barrier (i.e., when the written address needs to be recorded) and in write barrier related processing steps sometimes more considered part of the garbage collector or sometimes performed by a background thread.

The objective is to reduce the overall overhead in a garbage collecting system due to the write barrier and related functionality, and to leave more freedom in other design tradeoffs relating to object layouts and access to old values of written cells.

The objective could also be partially paraphrased as eliminating the TLB misses due to updating the very large card table, eliminating card scanning or RS buffer scanning time and overhead, and optimizing updating remembered sets based on information saved by the write barrier. The new write barrier method also makes it possible to save the original value of written cells, which is beneficial or even required in some garbage collection systems well suited for multiprocessor systems with very large memories, such as the multiobject garbage collector presented in U.S. Ser. No. 12/147,419.

A write barrier buffer (also called remembered set buffer or RS buffer in the literature) according to the present invention uses a lock-free open addressing hash table, preferably with a multiplicative hash function, to implement the write barrier buffer. Each written address is stored only once in the hash table. The size of the hash table may be dynamically adjusted to keep collisions under control.

A significant performance improvement in the present method comes from avoiding the TLB miss that is frequently associated with card marking with large memories. A TLB miss costs about the same as a thousand simple instructions (the cost having steadily increased year-by-year as processor cores become relatively faster and faster compared to memory speeds). Thus, even though a write barrier according to the present invention executes more instructions than a traditional card marking based write barrier, those instructions execute much faster in modern systems.

In some preliminary tests (single-threaded, but with atomic instructions) we found a hash table insertion into a reasonably sized hash table to consume about 19 nanoseconds on an AMD 2220 processor, compared to about 189 nanoseconds for marking a card, and 11 vs. 34 ns on an Intel i7 965 processor (8 GB memory, 512 byte cards). The difference is mostly due to a lower TLB miss rate associated with the hash table.

The methods of the present disclosure are particularly beneficial in computer systems with large memories and incremental (or real-time) garbage collection. Such systems generally must maintain remembered sets anyway, and can benefit significantly from combining writes to the same address. The benefit becomes greater as the complexity of the remembered set data structures increases; the cost generally tends to become higher in systems utilizing concurrency or designed for very large memories, distributed systems, and persistent storage systems. Thus, the highest benefit from the present invention can be realized in such systems.

A further benefit is allowing more freedom for designing other parts of the garbage collector. There is no need to scan cards (which requires knowing which memory locations contain valid pointers and which are other data, such as raw integers or floating point numbers). The old value of each written location can be made easily available to the garbage collector, which is difficult to do consistently and efficiently in a log-structured RS buffer based scheme. Pause times are reduced by having each written memory location in the remembered set buffer exactly once.

In mobile computing devices, such as smart phones, personal digital assistants (PDAs) and portable translators, reduced write barrier overhead translates into lower power consumption, longer battery life, smaller and more lightweight devices, and lower manufacturing costs. The hash table based write barrier, due to its lower memory requirements, is also more amenable to direct VLSI implementation.

In large computing systems with very large memories, using a lock-free hash table based write barrier both reduces memory requirements and improves overall performance of the entire system. The increased flexibility allows implementing other parts of the garbage collector and the rest of the execution environment more optimally, resulting in indirect benefits.

The focus of the present disclosure is on the write barrier component and improvements thereto, and the mechanisms disclosed herein can be used in a garbage collector regardless of whether its remembered sets are organized as a global hash table, a hash table per region, a global index tree, an index tree per region, or some other suitable data structure, or entirely non-existent in the traditional sense.

### BRIEF DESCRIPTION OF THE SEVERAL VIEWS OF THE DRAWING(S)

FIG. 1 illustrates a computer system with a lock-free hash table based write barrier buffer for a multiprocessor garbage collector.

FIG. 2 illustrates the fast path component.

FIG. 3 illustrates the slow path component from a data flow viewpoint.

FIG. 4 illustrates lock-free insertion of an address and old value into a write barrier buffer implemented as an open addressing hash table.

FIG. 5 illustrates the slots and fields of the write barrier buffer hash table.

FIG. 6 illustrates a computer usable software distribution medium for causing a computer system to implement a write barrier buffer as described herein.

### DETAILED DESCRIPTION OF THE INVENTION

A computing system according to the present invention comprises a garbage collector means for managing memory. Any known or future garbage collection means can be used (many such methods are described in the book by Jones & Lins).

Known garbage collection methods for general purpose computers that are suitable for systems with large memories requiring incremental collection utilize a write barrier to record certain information about written memory locations. Which writes need to be recorded and what information needs to be recorded about them varies from system to system. However, the write barrier implementation can be considered relatively independent of the particular garbage collection method selected.

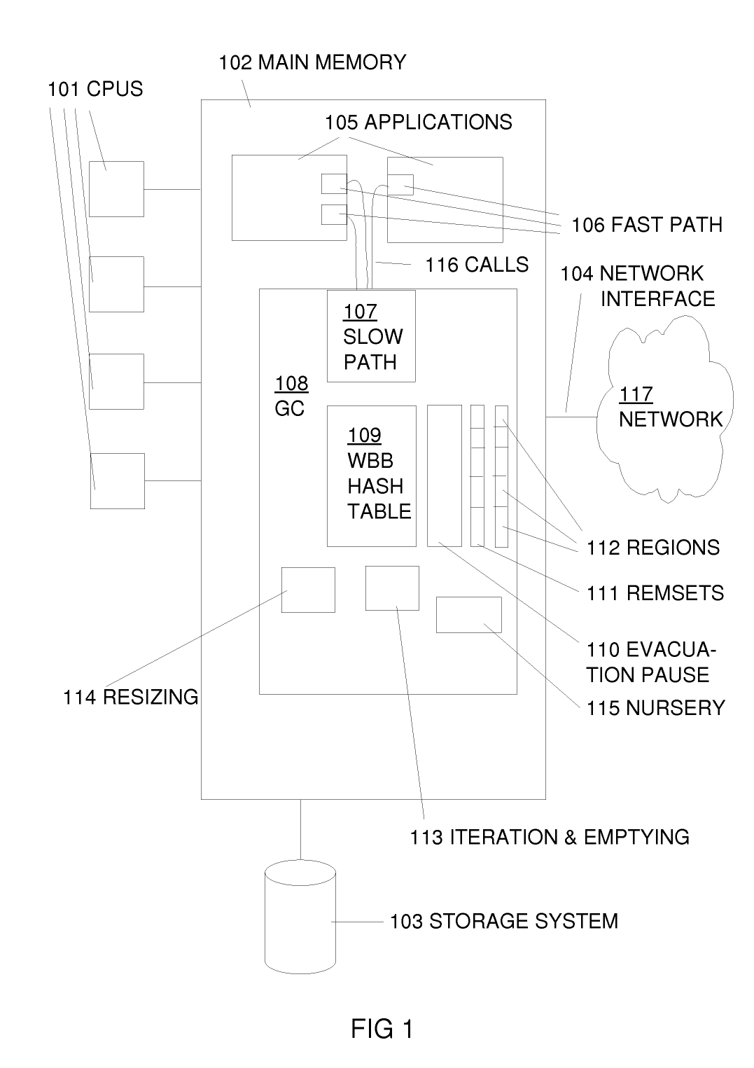

The write barrier is a key interface between the application programs being executed on the computing system and the garbage collector/memory manager component. This structure is illustrated in FIG. 1, which shows a computing system according to the present invention. The key hardware components of a general-purpose computer, such as processors (101), main memory (102), storage subsystem (103) and network interface(s) (104) that connect the computing system to a data communications network (117) are well known in the art. Modern high-end computer systems comprise several processors and several hundred megabytes to tens of gigabytes of fast main memory that is directly accessible to the processors. Clustered computing systems may employ thousands of computing devices working in tandem, and may utilize distributed garbage collection and/or distributed shared memory, with some or all nodes incorporating a write barrier buffer according to the present disclosure.

A general purpose computer is configured for a particular task using software, that is, programs loaded into its main memory. Without the programs, the computer is useless; the programs make it what it is and control its actions and processes. Most of the essential components of a modern computer are software constructs; while composed of states in memory, they control the tangible activity of the computer by causing it to perform in a certain manner, and thus have a physical effect.

The programs for configuring the computer are normally stored in its storage system (or in the storage system of another computer accessible over the network), and are loaded into main memory for execution.

A general purpose computer generally comprises at least one operating system loaded into its main memory, and one or more application programs whose execution is facilitated, monitored and controlled by the operating system.

Modern operating systems and applications typically use garbage collection to implement automatic memory management. Such automatic memory management carries significant benefits by improving program reliability and reducing software development costs. A key obstacle for widespread use of garbage collection in the past has been overhead, but improvements in processor performance as well as better garbage collection methods have made it possible to utilize it on a broad range of systems.

The garbage collector component in the system may technically be part of the operating system, part of some or all application programs, or a special middleware or firmware component, such as a virtual machine shared by many applications. Some or all of the garbage collector may also be implemented directly in hardware; it can be anticipated that as Java and other languages utilizing garbage collection become even more widespread, the pressure for supporting some operations, such as a write barrier, in hardware will increase. Some computing systems employ multiple garbage collectors simultaneously, e.g. one for each application that needs one.

An application that utilizes garbage collection typically uses a write barrier to intercept some or all writes to memory locations by the application. The write barrier comprises a number of machine instructions that are typically inserted by the compiler before some or all writes (many compilers try to minimize the number of write barriers inserted, and may eliminate the write barrier if they can prove that the write barrier is never needed for a particular write). Some compilers may support a number of specialized write barrier implementations, and may select the most appropriate one for each write.

The write barrier can generally be divided into a fast path and a slow path component. The fast path is executed for every write, whereas the slow path is only executed for writes that actually need to be recorded (usually only a few percent of all writes). Both may be implemented in the same function, but more frequently (for performance reasons) the fast path is inlined directly where the write occurs, whereas the slow path is implemented using a function call. Some write barrier implementations only consist of a fast path with a few machine instructions, but these barrier implementations tend to have rather limited functionality and are generally not sufficient for large systems.

In the preferred embodiment of the invention described herein, the application programs (105) comprise any number of write barrier fast path instantiations (106). In the figure, it is assumed that the slow path (107) is implemented only once in the garbage collector (108), in some kind of firmware, virtual machine, or library; however, it could equally well be implemented in each application, in the operating system, or, for example, partially or entirely in hardware.

The slow path of the write barrier stores information about writes to the write barrier buffer hash table (109). During evacuation pauses, the write hash table is also used by the code that implements garbage collection (110) (typically implementing some variant of copying, mark-and-sweep, or reference counting garbage collection) or code that runs in parallel with mutators in a separate thread and updates remembered sets (111) using information in a remembered set buffer. Most garbage collectors have one remembered set per independently collectable memory region (112) or generation, though this need not necessarily be the case.

The garbage collector reads information from the hash table using an iteration means (113). It also empties the hash table; preferably this emptying is combined with the iteration means. The garbage collector may also make queries to the write barrier buffer based on the address, as the write barrier buffer is a hash table and it can be checked very quickly whether a particular address is in the hash table. A resizing means (114) is used to handle situations where the hash table becomes too full, as described below.

The main memory typically also comprises a nursery (115) used for very young objects. In most systems, the write barrier need not record writes to the nursery, and the fast path of the write barrier typically checks whether the write is to the nursery, and only calls (116) the slow path if it is not.

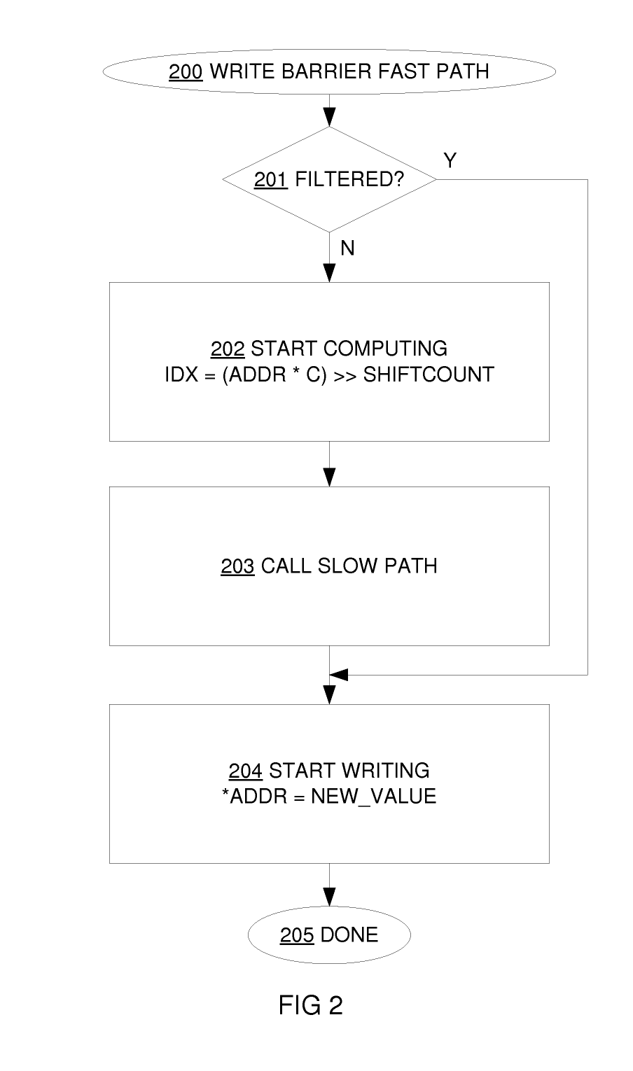

The fast path component (200) is described in FIG. 2. First, in (201) the fast path tests whether the write is to the nursery or otherwise filtered. If the write is to the nursery, nothing more needs to be done by the write barrier, and execution proceeds to (204) to perform the actual write.

The test in (201) is intended to cover all sorts of filtering operations that may occur in the write barrier fast path (additional filtering may also occur in the slow path). Such filtering may e.g. filter out stores of constant values, writes to the nursery, writes whose values are within the same region as the written address, popular objects, writes whose value is in an older generation, etc. Many such filtering mechanisms are known in the literature, and which ones are used in a particular implementation depends on the details of the garbage collector, the compiler, and the architecture.

In the preferred embodiment, the next step (202) starts computing the index into the hash table, already before calling the slow path in (203). This differs from the prior art. Since most modern high-performance general purpose processors are superscalar (i.e., they can execute multiple, typically about three instructions in parallel), it is possible to start a computation that takes several clock cycles, and move on to do other processing before the value of the computation is actually needed. By starting the computation of the index into the hash table already in the fast path, its computation is overlapped with the function call, and thus the index gets computed at nearly zero extra cost compared to the function call.

The preferred embodiment computes the index into the hash table by multiplying the address of the memory location being written by a large constant using 32-bit or 64-bit multiplication combined with selecting the highest bits of the result (currently we prefer 32-bit multiplication, ignoring the upper 32 bits of a 64-bit memory address in the computation of the hash value). The multiplication is by a suitable constant that causes the result to overflow and the high-order bits of the result to depend roughly equally on all bits of the memory address (or its lower 32 bits). The index into the hash table is taken from the high order bits, as the bits of the address are more uniformly mixed here.

In all simplicity, the index computation is:

index=((UInt32)addr*c)>>shiftcount.

This is very simple to implement in software (roughly two instructions) when the multiplication is a 32-bit or 64-bit integer multiplication; however, in custom logic the multiplication is quite expensive, and any known hash function with an output of the suitable size could be used instead. The cryptographic literature contains extensive teachings on how to construct efficient hash functions for hardware implementation with good diffusion and mixing properties (the hash function used here does not need to be cryptographically strong, however). In implementations where the hash table size is not expanded, the shift may have a constant count, may be replaced by a bitwise-and operation, or may perhaps be entirely omitted if the hash table size is e.g. 2̂8, 2̂16, or 2̂32.

Separating the computation of the hash value from other hash table operations and initiating it already in the fast path, utilizing the parallelism inherent in modern superscalar processors, allows the computation to be performed at essentially zero cost (the latency of a multiplication followed by a shift is of the same order of magnitude as a function call, so they parallelize very nicely). This alone reduces the cost of hash table operations by several percent, possibly some tens of percent, when all data is already in cache (which will be relatively frequent with hash table based write barrier buffers, as the hash table will be much smaller than a card table), and is thus an important improvement over existing methods.

In (203) the slow path is called, giving the address and the index to it as an argument (in an actual implementation on e.g. current Intel or AMD processors, the processor does not stall waiting for its computation to complete so it actually runs in parallel with the call). Other arguments may also be given, such as an address of the header or cell of the object containing the written address.

Finally, in (204) the new value is written to the memory location, or more precisely, writing it is scheduled into the execution unit of the processor. An earlier read (403) from the same location may still be executing at this point, in which case the write may need to be delayed until the earlier write has completed. Note, however, that modern superscalar processors can handle such situations without stalling the execution of other instructions that do not depend on the results of the read and write. Thus the write here does not typically reduce the benefits of performing (403) and (404) interleaved with other activity.

At (205) execution of the application program (mutator) continues after the write.

Alternatively or in addition to starting the index computation before the call to the slow path one could also start reading the old value of the written memory location (also at (202)). However, currently it seems that the best mode is to not start the read yet in the fast path, because the old value is only needed if the address is not already in the hash table, and because on many processors compare-and-swap instructions would wait for the read to complete, actually reducing performance. In some embodiments the filtering step may also need the old value. As an alternative, the fast path could also start computing the hash value or read before the filtering step (201).

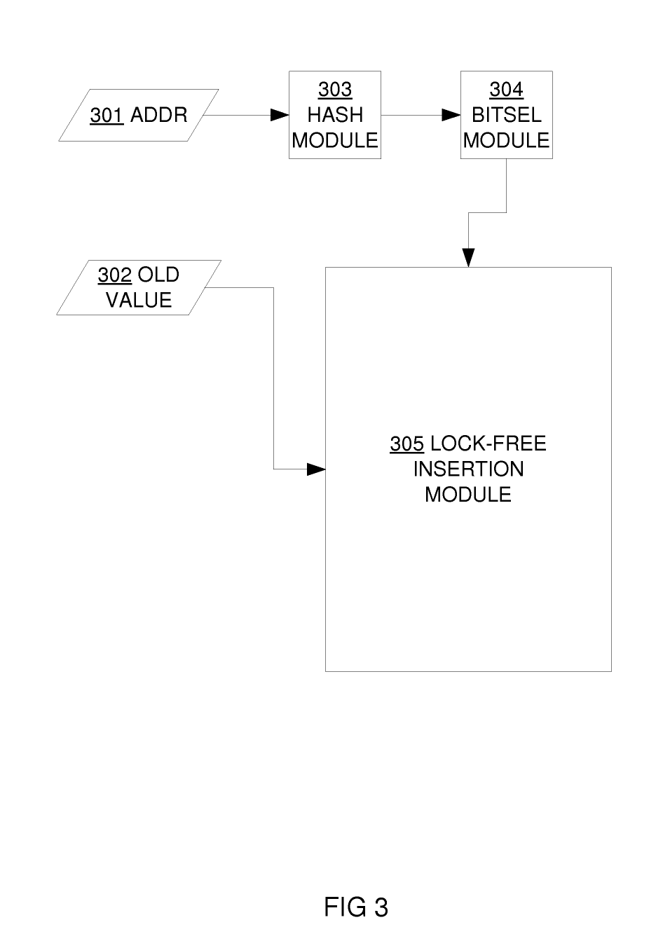

FIG. 3 illustrates the data flow of the slow path of the write barrier (the computation of the index is also shown here, as it could be implemented in the slow path, although in the preferred mode it is started already in the fast path). (301) is the address; this is passed to logic (303) that computes a hash value from it (in the preferred mode in software a multiply instruction, but in hardware implementations this would likely be a hash function implemented directly using logic elements). The bit selection module (304) selects the desired number of bits from the hash value (in the preferred mode, by shifting the value right; the shift count is N−M, where the word size for the multiply was 2̂N (N usually 32 or 64), and 2̂M is the size of the hash table. (305) stands for the module for performing lock-free insertion of the address and the old value (302) of the written memory location into the hash table.

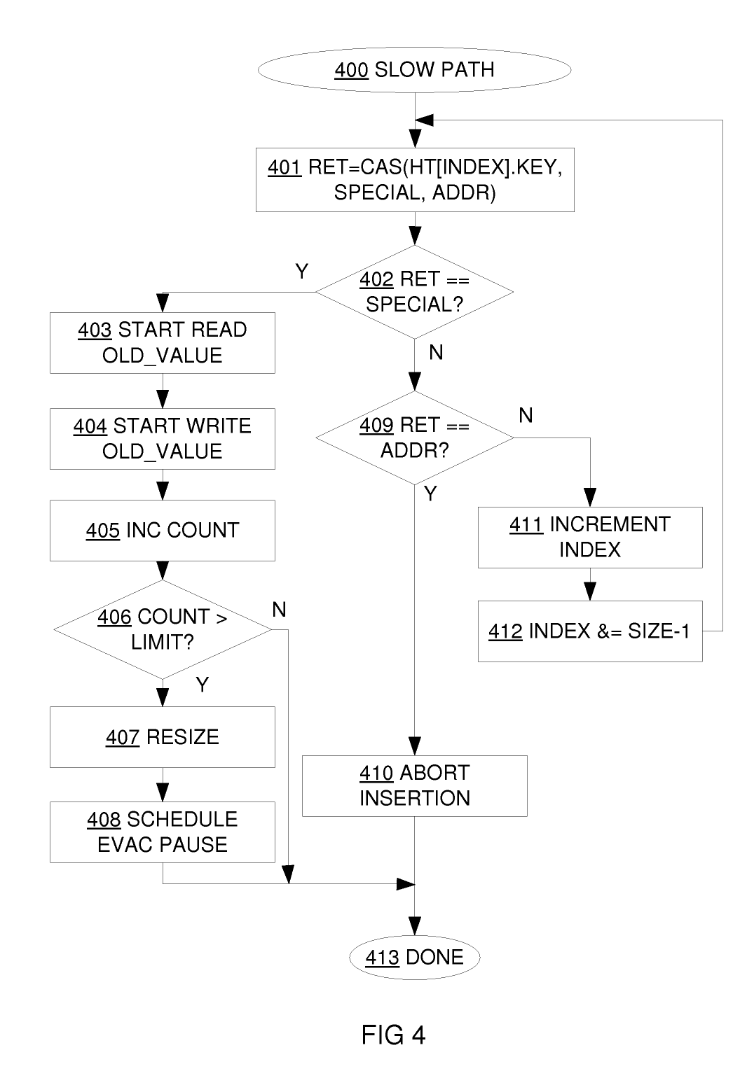

FIG. 4 gives a more detailed description of the slow path (400), and especially the lock-free insertion of the address and the old value of the address into the hash table.

Step (401) illustrates the use of an atomic compare-and-swap (CAS) instruction. Such instructions are well known in the art. A compare-and-swap instruction reads a memory location, compares it against a given expected value, and if they match, writes a given new value to the memory location. In each case it returns the old value of the memory location (the return value and the way of returning it differs slightly between architectures), all as a single atomic operation with respect to serialization of operations on a multiprocessor or multi-core computer. Alternatively, the same effect can be achieved by using load linked/store conditional instructions, double compare-and-swap (DCAS), or other similar equivalent instruction sequences as is well known in the art.

As used in (401), the memory location compared and modified in the compare-and-swap operation is preferably ‘&ht[idx].addr’, meaning the address of the written address field in the hash table slot at the index computed in (303) and (304). The old value is the special value used to indicate that the slot is free, preferably 0. The new value to be assigned is the address of the written memory location in the application (i.e., the address for which the write barrier was called). The compare-and-swap instruction returns the old value of the modified location (or e.g. indicates by processor flags whether the write occurred, depending on architecture, as is known in the art).

In (402), it is checked whether the compare-and-swap instruction successfully modified the memory location (in the preferred embodiment, by comparing the returned value against the special value, preferably 0). If it was successful, execution continues from (403), where a read of the original value (old value) of the written memory location is initiated, and (404), where a write of the original value into the appropriate field of the indexed hash table slot is scheduled to be executed once the read completes. Note that the read may incur a TLB miss and last up to about a thousand instructions; on a superscalar processor this initiating and scheduling of the read and write is done by executing the read and write instructions, but because of how the overall algorithm is structured, they have no dependencies with other code or atomic instructions, and thus can execute fully in parallel with other instructions. A superscalar processor will automatically delay the write instruction until the read completes, as a dependency exists between them. In a custom logic implementation or a specialized processor, this scheduling could be implemented using a state machine or other suitable logic structures. As an alternative, the read could be initiated already while the CAS instruction is running, allowing more parallelism.

Execution then continues with (405) to count the added item and (406) to check whether the hash table is now too full. If it is too full, the condition may be remedied by switching, expanding, requesting immediate garbage collection, or other suitable means. The code for these actions is denoted by (114) in FIG. 1.

In case the hash table is switched, a new hash table is allocated or taken from e.g. a list, and a pointer to the current hash table (‘ht’) is atomically replaced, e.g. using a compare-and-swap instruction. Multiple threads may try to switch the hash table simultaneously, but the compare-and-swap instruction is used to detect if it has already been switched, so that only one thread can successfully switch it at any given time. If the compare-and-swap instruction indicates that it was already switched by another thread, the newly allocated hash table can be freed or e.g. put back on a freelist, and the slow path operation restarted.

In case the hash table is expanded, any known or future lock-free hash table expansion method may be used. It should, however, be noted that making a lock-free hash table expandable typically incurs extra overhead, and it may be desirable to avoid such overhead in a write barrier, which is highly performance-critical and whose set of operations and their frequency distribution differs significantly from that typical in general-purpose hash table designs. Expanding (resizing) the hash table is shown as (407) (though the label should be interpreted as including any method for remedying the too full condition).

The initial size of the hash table may be computed from system parameters or loaded from a file, and its size may be dynamically adjusted after at least some evacuation pauses at run time to reduce the number of hash table expansions, which are fairly expensive operations, and to reduce the cost of future iterations. The system can collect smoothed statistics of the number of writes performed by the application between evacuation pauses or per a time period, and adjust the hash table size accordingly. Alternatively, it may be made large enough to contain the number of writes that occurred between the previous pair of evacuation pauses. Its size may also be reduced.

In the switching method, not all hash tables need to be of the same size. A preferable approach is to always make the next hash table twice the size of the previous hash table, which keeps the number of hash tables small in all situations.

In case immediate garbage collection is requested, the write barrier would call the garbage collector (for just processing the write barrier buffers, for doing an incremental evacuation pause, or at the extreme doing a full GC). This would require that the write barrier be a valid GC point in the architecture (see e.g. O. Agesen: GC Points in a Threaded Environment, Sun Microsystems report SMLI TR-98-70, 1998), which is the case on many architectures. The garbage collector would also need to treat registers used by the write barrier implementation as program registers and update any values and pointers contained therein as appropriate (and well known in the art).

The garbage collection may also be requested to start soon after completing the write barrier (e.g. when the next GC point is entered), probably avoiding the need to actually remedy a too full condition, though it may not always be avoided. The request is preferably done by setting a global variable. In this case the write barrier need not be a GC point.

Checking whether the hash table has become too full could be based on a number of approaches. First, one should note that the check could alternatively be placed anywhere in the loop through (411). In the loop, a possible criterion would be the number of iterations through the loop, which is indicative of the level to which the hash table has been filled. Another possible criteria is comparing the number of items added to the hash table against a limit based on the current size of the hash table (406), and having a global counter indicate how many items have been added (the counter itself updated atomically, using e.g. a locked increment or a compare-and-swap instruction, or any other known method) (405). A further possible approach is to generate a random number using a thread-local seed at (405), compare the random number against a constant, and perform any of the operations discussed above for (405) if the random number is small (or large) enough, the constant controlling the probability. Other methods are also possible.

The preferred mode is to count the number of times the loop has been iterated through (411) using a local variable or register, and if the count exceeds a limit, use the switching method.

Regardless of how the hash table becoming too full is checked and handled, it may be desirable to cause garbage collection to happen either immediately or very soon if excessively many addresses have been written. The main reason for this is ensuring that the evacuation pause that needs to process the written addresses can complete within its allotted time. Causing the garbage collection to happen may involve e.g. calling the garbage collector directly, setting a flag that causes the garbage collector to be called (e.g. when the application next enters a GC point), by scheduling the garbage collector through a timeout, or any other suitable mechanism. These actions are illustrated by (408).

At (409) we know that the compare-and-swap instruction failed. Such failure indicates that the slot is already in use, containing either the same written address or a different written address. (409) checks which case it is. If it is the same address, then it is already in the hash table, and the insertion is aborted (410), typically by returning from the slow path function. Otherwise the slot must already be occupied by another address, and another slot must be tried. (411) illustrates computing the next address. Many ways of dealing with such conflicts have been discussed in the literature, including linear probing (incrementing the address by one modulo the size of the hash table), double hashing, chaining, etc.

Since the hash function and bit selection method in the preferred mode yields an index where the entropy of the written address is fairly equally divided among the bits of the index, the size of the hash table can be allowed to be a power of two (rather than using the more conventional modulo prime number mixing which prefers prime sized hash tables). The size of the hash table being a power of two allows faster bit selection (bitwise-and instead of modulo), and also allows faster incrementing, as the modulo in the increment can be computed using a bitwise-and instruction in (412) (basically, ‘idx=(idx+1) & (size−1)’), which is faster than either a modulo or a conditional assignment. Both (411) and (412) can also be computed in parallel with (401), overlapping the CAS instruction on a superscalar processor, at essentially zero cost, which may justify computing them every time, even though the result is rarely needed.

At (413) the slow path of the write barrier is complete, after which the actual new value of the written memory address should be stored. It should, however, be noted that the read and write performed in (403) and (404) may still continue for hundreds of instructions after the write barrier has completed, executing in parallel with other code. This parallelism gives a significant reduction of the overall cost of the write barrier.

The write barrier buffer hash table is typically iterated when an evacuation pause starts, though it is also possible to predictively start a thread that iterates and/or empties the hash table, similar to the thread for emptying RS buffers in David Detlefs et al: Garbage-First Garbage Collection, ISMM'04, pp. 37-48, ACM, 2004; such a thread might most advantageously be combined with the switching method described above.

When a single hash table is used, iteration of the hash table is fairly trivial and well known in the art, especially if the iteration can be performed by a single thread. It could also be done in parallel (e.g. by dividing the slots into a set of slot ranges, each processed by a separate thread).

Iteration is much more complicated when using the switch approach for remedying the too full condition. In that case, multiple hash tables may exist, and the same address may occur multiple times (at most once per hash table, though). Logically the individual hash tables should be combined into a single hash table for iteration purposes, and each address should only be iterated once (and with the oldest old value).

Such iteration is performed as follows. Two special marker values are used here, the first being the special value discussed earlier (preferably 0), and the second being a different value but invalid address (preferably 1).
iterate over the oldest hash table, and for each found address:
   if it is the second special marker, write the first special marker to it
   query the address from each younger hash table, and if found, write the second special marker to it, freeing it from the younger hash table
   pass the address (with the old value from the oldest hash table) to the evacuation pause
when the oldest hash table has been iterated, free it (or put it on a list), and repeat these steps until all hash tables have been processed.

This iteration method can be parallelized by partitioning the oldest hash table and processing each partition by a separate thread. The queries and deletions from younger hash tables can be performed without locking. A known open addressing linear probing hash table query (or lookup or get) algorithm is used for performing the queries (essentially advancing index until a slot with the queried address or the first special marker is found).

Another task that must be performed, typically during an evacuation pause, is emptying the hash tables. Emptying a hash table typically involves writing a known value (the first special value) to each slot of the hash table. We can optimize the emptying by merging it with the iteration means, writing the first special value to the current slot before or after passing the address to the evacuation pause.

While this description has mostly assumed that the write barrier buffer (hash table) is emptied by an evacuation pause, it could also be done using one or more separate background threads, similar to the approach in David Detlefs et al: Garbage-First Garbage Collection, ISMM'04, pp. 37-48, ACM, 2004. The intention is not to constrain when the hash table iteration and emptying may occur. In some collectors they may occur in parallel with mutator execution.

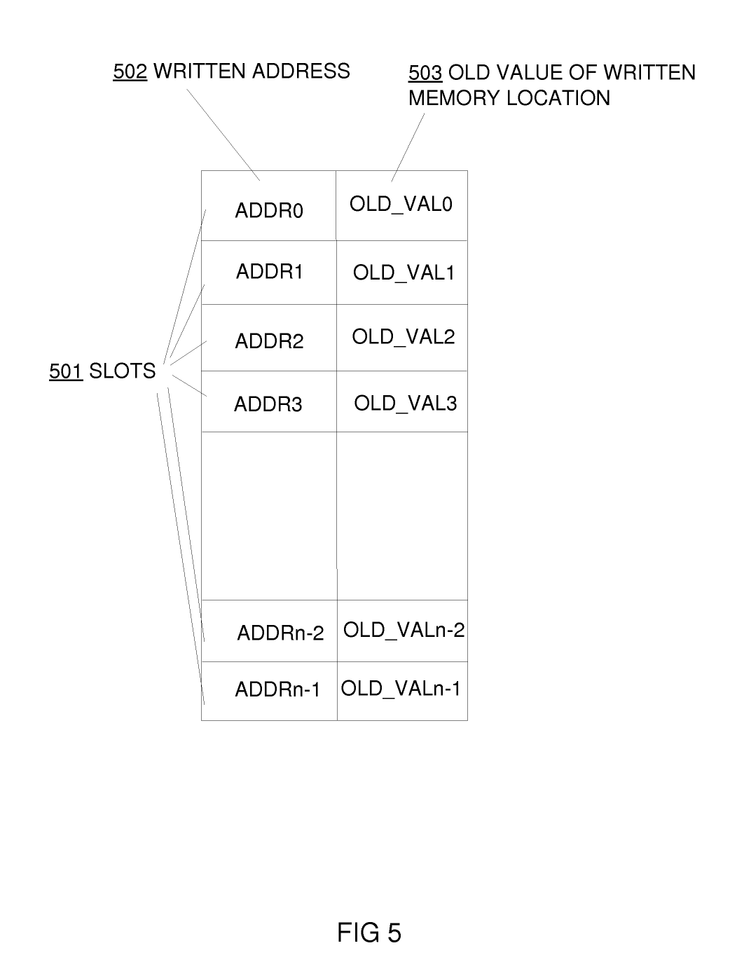

FIG. 5 illustrates the hash table data structure. Rows (501) illustrate slots, which are preferably data structures comprising at least a written address (502) and old value (503) fields. However, it could also contain other data, such as the address (or cell, including tags) of the object containing the written address, a special flag field (such address of the written object would be passed as a argument to the write barrier, and storing it would allow more flexibility for implementing other parts of the garbage collector). It would also be possible to store only part of the address and/or old value (e.g., only the lower order or significant bits), or a transformation of the values, or reorder the fields, without changing the essence of the invention. The number of slots in the hash table is preferably a power of two (2̂N), though other sizes are also possible.

When used with garbage collectors that do not require access to the old value of the written memory location, that field can naturally be omitted from the hash table, potentially making the hash table slots just memory addresses. Any steps related to loading and saving the old address can be omitted in such implementations.

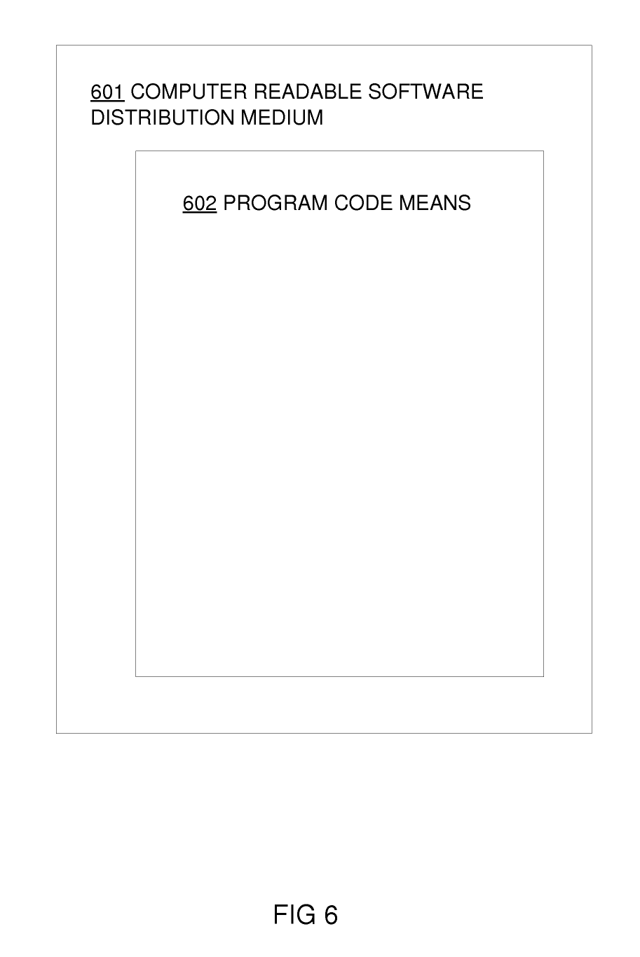

FIG. 6 illustrates a computer readable software distribution medium (601) having computer usable program code means (602) embodied therein for causing a computer system to perform garbage collection using a write barrier buffer, the computer usable program code means in said computer usable software distribution medium comprising: computer usable program code means for checking if a write must be recorded in a write barrier buffer; computer usable program code means for computing a hash value from the address of the memory location being written and indexing a hash table using at least some bits of the hash value; computer usable program code means for adding the address of the memory location being written to the hash table using a lock-free hash table insertion operation; computer usable program code means for aborting the insertion if the address of the memory location being written is already in the hash table; computer usable program code means for iterating over addresses stored in the hash table and emptying the hash table. Nowadays Internet-based servers are a commonly used software distribution medium; with such media, the program would be loaded into main memory or local persistent storage using a suitable network protocol, such as the HTTP and various peer-to-peer protocols, rather than e.g. the SCSI, ATA, SATA or USB protocols that are commonly used with local storage systems and optical disk drives, or the iSCSI, CFS or NFS protocols that are commonly used for loading software from media attached to a corporate internal network.

It should be noted that the write barrier component may be implemented as either software or as hardware. Any number of parts of the garbage collector could be implemented in hardware.

Clearly many reorderings of the steps in the described algorithms and a number of other transformations on the presented algorithms and structures are possible and available to one skilled in the art, without deviating from the spirit of the invention.

What is claimed is:

1. A computing system comprising:
at least one garbage collector
at least one write barrier buffer comprising a hash table
write barrier fast path means used in implementing at least some memory write operations
write barrier slow path means invoked in at least some cases by the fast path means, the slow path means comprising:
a means for computing a hash value from the address of the memory location being written and indexing the write barrier buffer hash table using at least some bits of the hash value
a lock-free hash table insertion means for adding the address of the memory location being written to the hash table
a means for aborting the insertion if the address of the memory location being written is already in the hash table
a means for iterating over addresses stored in the hash table, and
a means for emptying the hash table.

2. The computing system of claim 1, wherein:
the means for computing a hash value from the address of the memory location being written comprises multiplying the address by a large constant, the multiplication being a 32-bit or 64-bit integer multiplication
the size of the hash table is a power of two
the bits for indexing the hash table are taken from the high-order bits of the hash value by shifting the result of the multiplication right by the size of the multiplication minus base-2 logarithm of the size of the hash table
the size of the hash table is determined at run time.

3. The computing system of claim 1, wherein the computation of said hash value and extracting some bits from it is initiated in the write barrier fast path.

4. The computing system of claim 1, wherein the computation of the next address (411) modulo the size of the hash table (412) is performed at least partially in parallel with the computation of the compare-and-swap instruction (401).

5. The computing system of claim 1, further comprising:
a means for checking whether the hash table is too full
a means for remedying the hash table too full condition.

6. The computing system of claim 5, where checking whether the hash table is too full is based on counting the number of times the loop in the slow path is traversed.

7. The computing system of claim 1, wherein the means for remedying the hash table too full condition comprises switching the hash table.

8. The computing system of claim 7, further comprising:
using a compare-and-swap instruction to update a pointer to the current hash table
checking the result of the compare-and-swap instruction to determine whether the current thread successfully installed the new hash table
if it failed to install the hash table, freeing the new hash table and restarting at least part of the slow path operation.

9. The computing system of claim 7, further comprising:
iterating over the oldest hash table, and for each found address field whose value differs from the first special marker:
if it is the second special marker, writing the first special marker in it
querying the found address from each younger hash table, and if found, writing the second special marker over it in the younger hash table
when the oldest hash table has been iterated, freeing it and repeating these steps until all hash tables have been processed.

10. The computing system of claim 5, further comprising:
requesting garbage collection to be started soon
honoring the request when the application reaches a GC point.

11. The computing system of claim 1, further comprising:
after the hash table has been emptied, dynamically reducing its size to a power of two that is estimated to minimize future overhead.

12. The computing system of claim 1, wherein iterating over the hash table is performed by:
partitioning the slots of the hash table into more than one partition
using more than one thread to iterate over the partitions, each partition iterated by one thread.

13. The computing system of claim 1, wherein the write barrier buffer hash table is a lock-free open addressing hash table whose size is a power of two.

14. The computing system of claim 1, wherein each slot of the hash table contains a data structure comprising at least fields for the address of a written memory location and the old value of that memory location when it was inserted into the hash table.

15. The computing system of claim 14, wherein each slot also contains the address of the header of the object containing the written address.

16. The computing system of claim 14, wherein the field for the address of a written memory location is set to a special indicator value when the hash table is emptied.

17. The computing system of claim 1, wherein the field for the address of a written memory location is atomically checked for the special value and written with a valid address using a compare-and-swap instruction, and thereafter:
if the result of the compare-and-swap instruction indicates that the slot was empty, writing the old value of the written location using a normal non-atomic write instruction
if the result of the compare-and-swap instruction indicates that the slot already contained the same address that is being written, aborting the insertion
otherwise incrementing the index modulo the size of the hash table, and attempting insertion again but with the new index.

18. The computing system of claim 1, wherein reading the old value of the memory location being written occurs at least partially in parallel with the computation of the hash value, the index, or a compare-and-swap operation.

19. The computing system of claim 18, wherein reading the old value of the memory location being written is initiated after the compare-and-swap operation has been initiated but before it completes.

20. The computing system of claim 1, wherein reading the old value of the memory location being written and writing it to the appropriate slot in the hash table are scheduled while executing the slow path of the write barrier, but in at least some cases their execution continues after the write barrier has otherwise completed, in parallel with normal mutator execution.

21. The computing system of claim 1, wherein the means for emptying the hash table is combined with the means for iterating over addresses stored in the hash table, such that as each slot of the hash table is iterated, it is emptied by writing a special value to it.

22. A method for implementing a write barrier buffer in a computing system, the computing system comprising a garbage collector that comprises a write barrier buffer that comprises a hash table, and the method comprising the steps of:
checking if a write must be recorded in a write barrier buffer, and if it must be recorded:
computing a hash value from the address of the memory location being written
indexing a hash table using at least some bits of the hash value
adding the address of the memory location being written to the hash table using a lock-free hash table insertion operation
aborting the insertion if the address of the memory location being written is already in the hash table
iterating over addresses stored in the hash table
emptying the hash table.

23. The method of claim 22, wherein:
said computing a hash value from the address of the memory location being written is performed by a 32-bit or 64-bit integer multiplication
the size of the hash table is a power of two
the bits for indexing the hash table are taken from the high order bits of the hash value by shifting the result of the multiplication right by the size of the multiplication minus base-2 logarithm of the size of the hash table
the size of the hash table is determined at run time.

24. The method of claim 22, further comprising the step of:
checking whether the hash table is too full
remedying the condition if the hash table is too full.

25. The method of claim 22, further comprising the step of:
atomically checking if the slot indicated by the index in the hash table is empty using a compare-and-swap instruction, and
if the slot is empty, storing the address of the written memory location and the old value of the memory location in the slot
if the slot already contains the same address, aborting the insertion step
otherwise incrementing the index modulo the size of the hash table, and repeating the above for the new index.

26. The method of claim 22, further comprising in this order the steps of:
initiating the reading of the old value of the written memory location
initiating the writing of the old value of the written memory location to the slot in the hash table
completing the reading of the old value of the written memory location
completing the writing of the old value of the written memory location to the slot in the hash table,
further characterized by at least some of these steps taking place after otherwise completing the execution of the write barrier and in parallel with normal mutator execution.

27. The method of claim 22, further comprising in this order the steps of:
initiating computing of the hash value and the index from it
calling the write barrier slow path.

28. A computer usable software distribution medium having computer usable program code means embodied therein for causing a computer system to perform garbage collection using a write barrier buffer, the computer usable program code means in said computer usable software distribution medium comprising:
computer usable program code means for checking if a write must be recorded in a write barrier buffer
computer usable program code means for computing a hash value from the address of the memory location being written and indexing a hash table using at least some bits of the hash value
computer usable program code means for adding the address of the memory location being written to the hash table using a lock-free hash table insertion operation
computer usable program code means for aborting the insertion if the address of the memory location being written is already in the hash table
computer usable program code means for iterating over addresses stored in the hash table and emptying the hash table.

29. The computer usable software distribution medium of claim 28, further comprising:
a computer usable program code means for checking whether the hash table is too full
a computer usable program code means for remedying the hash table too full condition.

30. The method of claim 28, further comprising:
a computer usable program code means for first initiating computing of the hash value and the index from it, and thereafter calling the write barrier slow path.
